(19) United States
(12) Patent Application Publication
(10) Pub. No.: US 2011/0316771 A1
(43) Pub. Date: Dec. 29, 2011

(54) Display apparatus, television reception apparatus and pointing system

(75) Inventor: Yasuhiro Kume, Osaka (JP)

(73) Assignee: Sharp Kabushiki Kaisha, Osaka-shi, Osaka (JP)

(21) Appl. No.: 13/138,514

(22) PCT Filed: Nov. 20, 2009
(86) PCT No.: PCT/JP2009/069693

§ 371 Date: Aug. 30, 2011

(30) Foreign Application Priority Data
Mar. 5, 2009 (JP) 2009-052243

(51) Int. Cl. G09G 5/00

(52) U.S. Cl. 345/156

(57) ABSTRACT

A display apparatus is connected to a computer that constitutes an external device. In at least one example embodiment, the external device outputs an image to the display apparatus via a video output port. When a pointing device directs a laser beam towards an image display module of the display apparatus, the display apparatus detects the laser beam using an incorporated photosensor, and identifies the coordinates in the image corresponding to that photosensor. Then, the location information for the identified coordinates is output to the external device via a pointing device input port. The external device recognizes the coordinate location and outputs a cursor indicating the pointer location superimposed on the output image. The display apparatus displays an image containing the cursor on the display screen.

### TECHNICAL FIELD

The present invention relates to a display apparatus, a television reception apparatus and a pointing system including a light detector.

### BACKGROUND ART

Conventionally, a laser pointer is used in presentations where a large screen is employed. For example, a user conducting a presentation directs a laser beam from a laser pointer onto an image displayed on the large screen to point to specific locations on the display screen while conducting the presentation.

If the large screen is a liquid crystal display, however, locations pointed to by the laser pointer illuminating the display screen may be difficult to recognize. One reason is the outermost polarizing plate's low reflectance, which is typically about 4 percent. Another reason is that the luminous intensity of pixels displaying white is about 300 candelas while an image is displayed.

To solve the problem, a pointing device is known where a pointed-to location is identified based on an image of a display screen captured by an imager, and the identified location is output to a computer to display a pointer at the pointed-to location (see, for example, Patent Document 1).

### PRIOR ART

### Patent Documents

Patent Document 1: JP2007-257438A

### SUMMARY OF THE INVENTION

### Problems to be Solved by the Invention

However, providing an imager, such as a camera, in the pointing device results in a complicated arrangement of the pointing device.

The present invention was made to solve the problem. An object of the present invention is to provide a display apparatus with a simpler configuration of the pointing device.

### Means to Solve the Problem

To achieve the above object, a display apparatus according to the present invention includes: a display module that displays a display image based on a plurality of pixels; a light detectors disposed to correspond to said pixels for detecting a pointer beam directed onto the display image on said display module and outputting a detection signal; a pixel identifying module that identifies a pixel corresponding to a light detector that detected said pointer beam based on said detection signal; and a coordinate determining module that determines coordinates of a location in said display image illuminated by said pointer beam based on the pixel identified by said pixel identifying module.

In a display apparatus thus constructed, light detectors are disposed to correspond to pixels that display an image. An image identifying module identifies a pixel corresponding to a light detector that detected a pointer beam based on the detection signal. Based on the detection signal from the light detector, a location illuminated by the pointer beam can be identified. Thus, a pointing device with a simpler device configuration than in the above prior art can be employed.

The above display apparatus may further include a coordinate information output module that outputs coordinates determined by said coordinate determining module, wherein said display module may display a display image superimposed with a pointing cursor on said coordinates. In this case, the pointing cursor can be clearly displayed at the coordinate location illuminated by a pointer beam.

The above display apparatus may further include a command detection module that detects a predetermined command signal when light of a wavelength different from that of said pointer beam is detected. In this case, based on a change in wavelength of the pointer beam, it is possible to detect an input of a command at the location in the image corresponding to the location of the pixel illuminated with the pointer beam.

Alternatively, the above display apparatus may include a command detection module that detects a predetermined command signal when a predetermined electromagnetic signal is received. In this case, based on an electromagnetic signal instead of a pointer beam, it is possible to detect an input of a command at the location in the image corresponding to the location of the pixel illuminated with the pointer beam.

Preferably, in the above display apparatus, each of said light detectors may be a photosensor provided for each of said pixels for detecting light from outside. In this case, it is possible to detect, at the pixel level, an input of a command at the location in the image corresponding to the location of the pixel illuminated with the pointer beam.

Preferably, in the above display apparatus, each of said light detectors may be a photosensor provided for each of picture elements forming a pixel, for detecting light from outside. In this case, it is possible to detect, at the picture element level, an input of a command at the location in the image corresponding to the location of the pixel illuminated with the pointer beam.

Moreover, in the above display apparatus, each of said light detectors may include a photodiode. In this case, it is possible to make a compact display apparatus incorporating a photosensor.

Further, in the above display apparatus, said display module may be a liquid crystal panel and said light detectors may be integrated into an active matrix substrate of said liquid crystal panel. In this case, it is possible to make a compact display apparatus incorporating a photosensor.

Further, a television reception apparatus according to the present invention may use any one of the display apparatus described above.

Also, a pointing system according to the present invention may use any one of the display apparatus described above.

In a television reception apparatus or pointing system thus constructed using any one of the above display apparatus, light detectors are disposed to correspond to pixels displaying an image. A pixel identifying module identifies a pixel corresponding to a light detector that detected a pointer beam based on a detection signal. Thus, based on a detection signal from the light detector, a location illuminated by a pointer beam can be identified. As a result, a pointing device with a simpler device configuration than in the above prior art can be employed.

### Effects of the Invention

As described above, a display apparatus, a television reception apparatus and a pointing system according to the present invention have advantages that a pointing device with a simpler device configuration can be employed.

### BRIEF DESCRIPTION OF THE DRAWINGS

FIG. 1 is a schematic view of an entire pointing system;

FIG. 2 is a functional block diagram showing a configuration of the pointing system;

FIG. 3 is a functional block diagram showing a configuration of the display apparatus 1;

FIG. 4 is a circuit block diagram showing circuitry of the liquid crystal panel 32 and surrounding circuitry;

FIG. 5A is a schematic view illustrating an arrangement of photosensors 30 in a liquid crystal panel 32;

FIG. 5B is a schematic view illustrating an arrangement of photosensors 30 in a liquid crystal panel 32;

FIG. 5C is a schematic view illustrating an arrangement of photosensors 30 in a liquid crystal panel 32;

FIG. 5D is a schematic view illustrating an arrangement of photosensors 30 in a liquid crystal panel 32;

FIG. 5E is a schematic view illustrating an arrangement of photosensors 30 in a liquid crystal panel 32;

FIG. 6 is a timing chart for a liquid crystal display apparatus;

FIG. 7 is a cross sectional view of the liquid crystal panel 32;

FIG. 8 is a schematic view of the panel where a photodiode 39b constituting a photosensor 30b receives a laser beam of a blue wavelength through the color filter 53b;

FIG. 9 is a flowchart illustrating a process for identifying a location illuminated by a laser beam;

FIG. 10A is a schematic view of a scan image where a laser beam illuminates one pixel;

FIG. 10B is a schematic view of a scan image where a laser beam illuminates a plurality of pixels;

FIG. 11 is a schematic view of the panel where a photodiode 39b constituting a photosensor 30r receives a laser beam of a red wavelength through a color filter 53r;

FIG. 12 is a functional block diagram showing a configuration of a display apparatus 1; and

FIG. 13 is an implementation of the invention where photosensors are provided independently from picture elements or pixels.

### EMBODIMENTS FOR CARRYING OUT THE INVENTION

Now, preferred embodiments of the display apparatus of the present invention will be described referring to the drawings. The description below will be made with reference to an implementation where the present invention is employed in a liquid crystal display.

### 1. First Embodiment

### 1-1 Overview of the Invention

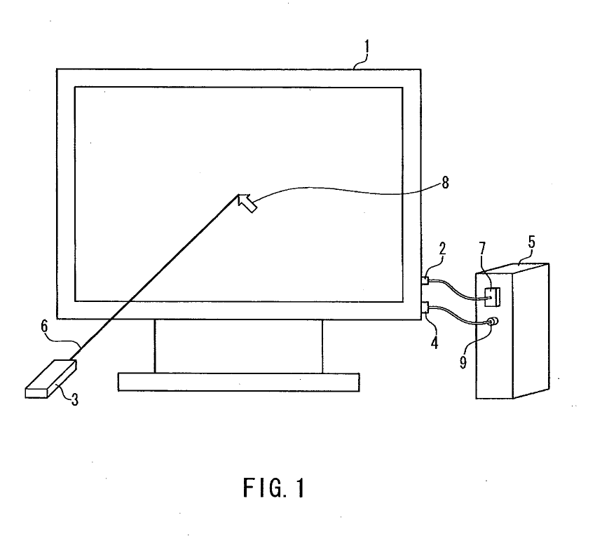

FIG. 1 is a schematic view of an entire pointing system using a display apparatus according to the present invention. A liquid crystal monitor (i.e. a liquid crystal display), which forms a display apparatus 1, is connected to a computer, which constitutes an external device 5, via two cables. An input port 2 of the display apparatus 1 is connected with a video output port 7 of the external device 5. The output port 4 of the display apparatus 1 is connected with a pointing device input port 9 of the external device 5.

The external device 5 outputs an image to the display apparatus 1 via the video output port 7. Upon receiving the output, the display apparatus 1 displays the image. When a laser pointer, which constitutes a pointing device 3, emits a laser beam 6 towards the image display module of the display apparatus 1, the display apparatus 1 detects the laser beam using incorporated photosensors and identifies the coordinates in the image corresponding to the photosensor that detected the beam. Then, the location information for the identified coordinates is output to the external device 5 via the pointing device input port 9.

Upon receiving the output, the external device 5 recognizes the coordinate location and superimposes a cursor indicating the pointing location upon the output image before outputting it. Upon receiving the output, the display apparatus 1 displays the image including the cursor 8 on the display screen.

Thus, in the pointing system according to the present invention, the display surface of the display apparatus may be directly illuminated with a laser beam (pointer beam) to clearly display the pointer cursor on the display screen.

### 1-2 Functional Block Diagram of Pointing System

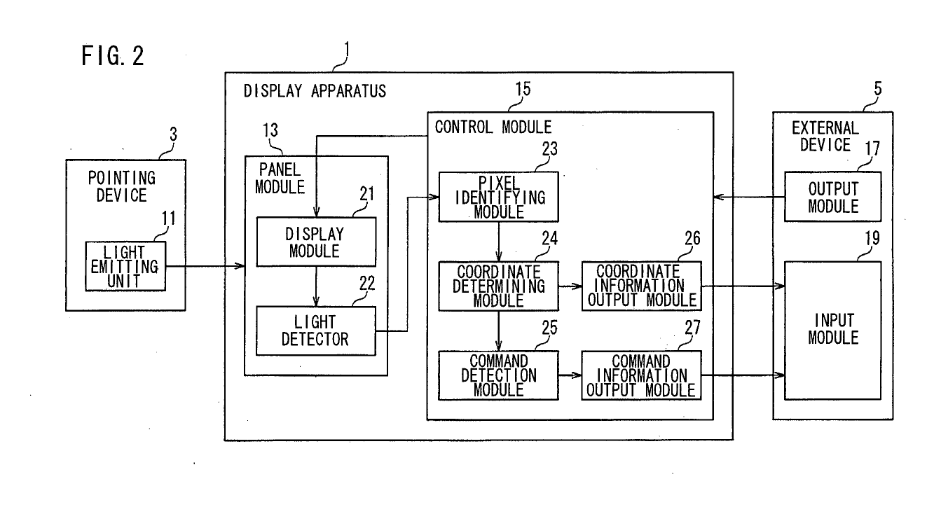

FIG. 2 is a functional block diagram showing a configuration of the pointing system of the present invention. The pointing device 3 includes a light emitting unit 11 for emitting a laser beam. The external device 5 includes an output module 17 for outputting image data to the display apparatus 1 and an input module 19 for receiving an input of coordinate information or command information from the display apparatus 1.

The display apparatus 1 includes a panel module 13 and a control module 15. The display module 21 of the panel module 13 displays an image output from the external device 5 using a plurality of pixels. A light detector 22 of the panel module 13 has units disposed to correspond to pixels of the display module 21 and detects any of the pixels of the display module 21 being illuminated with a pointer beam before outputting the detection signal.

By determining the pixel corresponding to the light detector that output a detection signal, the pixel identifying module 23 of the control module 15 identifies a pixel at the location on the display module 21 illuminated by a pointer beam. The coordinate determining module 24 determines coordinates in the image corresponding to the pixel identified by the pixel identifying module 23.

Then, the coordinate information output module 26 outputs information regarding the coordinates determined by the coordinate determining module 24. The command detection module 25 detects a command signal (for example, a click command) based on a detection of a laser beam of a wavelength different from that of the pointer beam. After the command detection module 25 detected the command signal, the command information output module 27 outputs an indication of an input of a predetermined command at the coordinates.

Thus, in the pointing system according to the present invention, information regarding a location illuminated by a laser beam directed from the pointing device 3 to the display apparatus 1 can be output as coordinate information to the external device 5. Also, when a command signal is detected, a detection of a predetermined command signal can be output as command information to the external device 5.

### 1-3 Functional Block Diagram of Display Apparatus

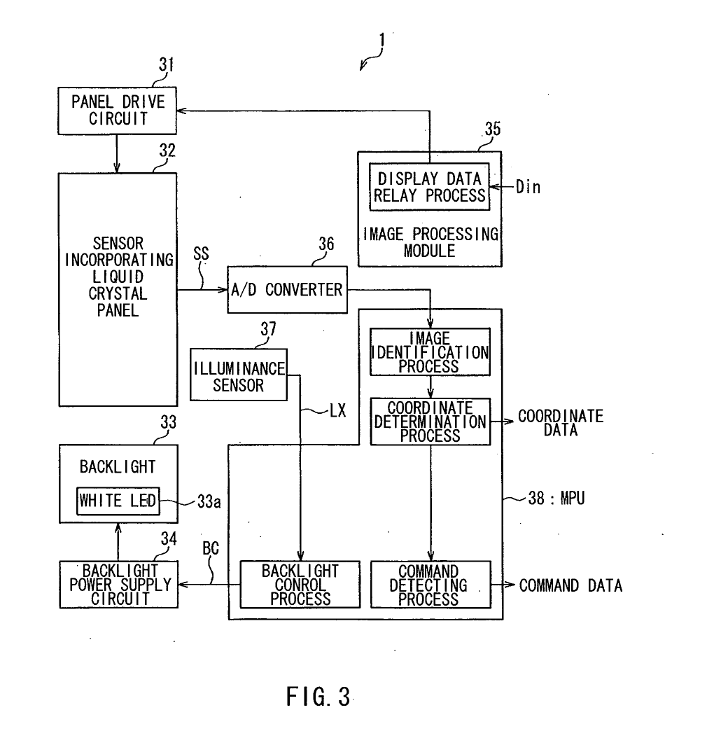

FIG. 3 is a functional block diagram showing a configuration of the display apparatus 1 of the present invention. The display apparatus 1 shown in FIG. 3 includes a panel drive circuit 31, a sensor incorporating liquid crystal panel 32, a backlight 33, a backlight power supply circuit 34, an A/D converter 36, an image processing module 35, an illuminance sensor 37 and a microprocessor unit (hereinafter referred to as MPU) 38.

The sensor incorporating liquid crystal panel 32 (hereinafter referred to as liquid crystal panel 32) includes a plurality of pixel circuits and a plurality of photosensors arranged two-dimensionally (details thereof will be given later). Display data Din is input to the display apparatus 1 from the external device 5. The input display data Din is supplied to the panel drive circuit 31 via the image processing module 35. The panel drive circuit 31 writes a voltage designated by the display data Din into a pixel circuit of the liquid crystal panel 32. Thus, an image based on the display data Din is displayed on the liquid crystal panel 32 using the pixels.

The backlight 33 includes a plurality of white LEDs (light emitting diodes) 33a to illuminate the back side of the liquid crystal panel 32 with light (backlight). The backlight power supply circuit 34 switches between on and off of the supply of a power supply voltage to the backlight 33 in response to a backlight control signal BC output from the MPU 38. In the following description, the backlight power supply circuit 34 supplies a power supply voltage when the backlight control signal BC is at high level, and does not supply a power supply voltage when the backlight control signal BC is at low level. The backlight 33 is on while the backlight control signal BC is at high level, and off while the backlight control signal BC is at low level.

The liquid crystal panel 32 outputs an output signal from a photosensor as a sensor output signal SS. The A/D converter 36 converts the analog sensor output signal SS into a digital signal. The output signal from the ND converter 36 indicates the location to which a laser beam from the pointing device 3 is pointed. Based on the sensor output signal SS acquired during the sensing period for coordinate information, the MPU 38 performs a location identification process for the laser beam to decide the illuminated location. Then, based on the results of the location identification process, the MPU 38 performs a coordinate determination process to determine coordinates in the image corresponding to the illuminated location, and outputs the determined coordinates as coordinate data Cout.

Further, based on the sensor output signal SS acquired during the sensing period for the command information, the MPU 38 performs a coordinate determination process and a command detection process to determine coordinates and detect a command at a coordinate location, and outputs the determined coordinates as coordinate data and outputs the detected command as command data.

### 1-4 Circuit Block Diagram of Display Apparatus

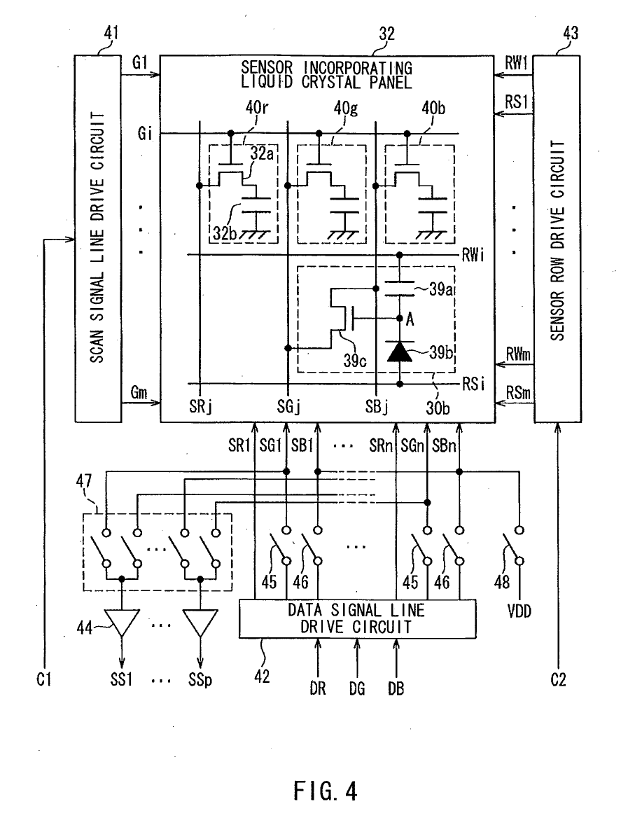

FIG. 4 is a circuit block diagram showing circuitry of the liquid crystal panel 32 and surrounding circuitry. FIG. 4 shows an implementation where a photosensor 30b is arranged in such a way that the R, G and B color filters are in a stripe arrangement and a photodiode 39b is located in the same column as the blue picture element 40b, that is, a photodiode 39b is located on the back side of a blue filter. It should be noted that other arrangements of color filters than a stripe arrangement may be employed, such as a mosaic arrangement or a delta arrangement.

For other pixels, not shown in FIG. 4, a photosensor 30r is provided in such a way that a photodiode 39b is located on the back side of the same red filter as for the red picture element 40r. Approximately the same number of photosensors 30b for the blue picture elements 40b and photosensors 30r for the red picture elements 40r are arranged in a regular manner.

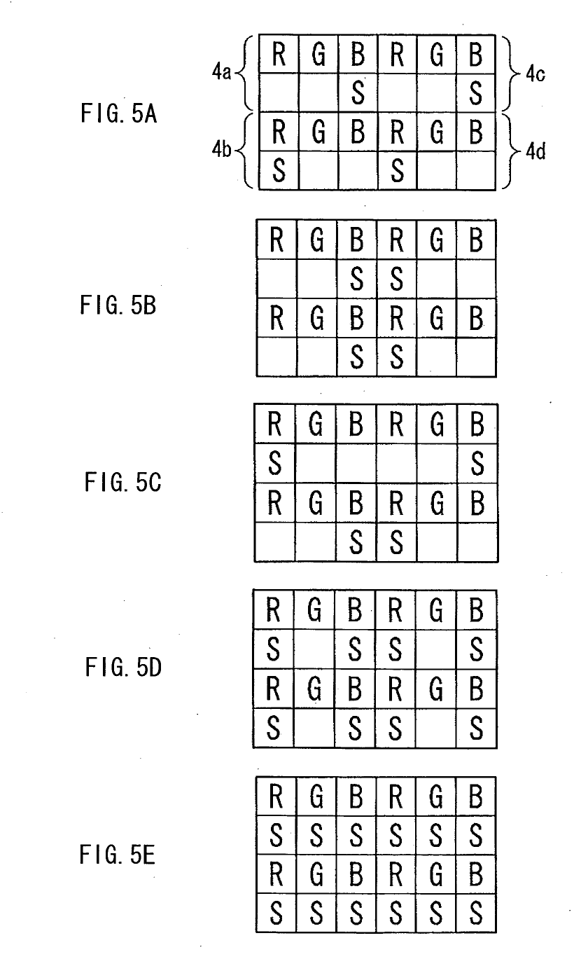

FIG. 5A is a schematic view illustrating an arrangement of photosensors 30 in the present implementation. In this drawing, “R”, “G” and “B” indicate red, green and blue picture elements, respectively, and “S” indicates a photosensor. In the pixels 4a and 4c, the photosensor “S” is positioned at the blue picture element “B”, while in the pixels 4b and 4d, the photosensor “S” is located at the red picture element 4b.

It should be noted that while in FIG. 5A, photosensors “S” are located at different picture elements for different horizontal lines, arrangements are not limited thereto. For example, as shown in FIG. 5B, photosensors “S” may be located at different picture elements for different vertical lines. Also, as shown in FIG. 5C, photosensors “S” may be located at different picture elements from one pixel to the next. Further, as shown in FIGS. 5D and 5E, photosensors “S” may be provided at each picture element.

Now, an implementation will be illustrated where a photosensor 30b, arranged in such a way that a photodiode 39b is on the back side of a blue filter in the same column as the blue picture element 40b, outputs a sensor output signal.

As shown in FIG. 4, the liquid crystal panel 32 includes m scan signal lines G1 to Gm, 3n data signal lines SR1 to SRn, SG1 to SGn, SB1 to SBn and (m×3n) pixel circuits 40 (40r, 40g and 40b), as well as (m×n) photosensors 30, m sensor readout lines RW1 to RWm and m sensor reset lines RS1 to RSm.

The scan signal lines G1 to Gm are disposed parallel to each other. The data signal lines SR1 to SRn, SG1 to SGn, SB1 to SBn are disposed perpendicular to the scan signal lines G1 to Gm and parallel to each other. The sensor readout lines RW1 to RWm and sensor reset lines RS1 to RSm are disposed parallel to the scan signal lines G1 to Gm.

Each pixel circuit 40 (40r, 40g and 40b) is disposed near the intersection between one of the scan signal lines G1 to Gm and one of the data signal lines SR1 to SRn, SG1 to SGn and SB1 to SBn. M pixel circuits 40 are disposed in each column (i.e. the vertical direction in FIG. 4), and 3n in each row (i.e. the horizontal direction in FIG. 4), in a two-dimensional manner as a whole.

Based on the color of their color filters, the pixel circuits 40 are classified into red (R) pixel circuits 40r, green (G) pixel circuits 40g and blue (B) pixel circuits 40b. The three types of pixel circuits 40r, 40g and 40b (hereinafter referred to as picture elements (subpixels)) are arranged in a row, where three circuits form one pixel.

A pixel circuit 40 includes a TFT (thin film transistor) 32a and a liquid crystal capacitor 32b. The TFT 32a has a gate terminal connected to a scan signal line Gi (i is an integer of not less than one and not more than m), a source terminal connected to a data signal line SRj, SGj or SBj (j is an integer of not less than one and not more than n) and a drain terminal connected to one of the electrodes of the liquid crystal capacitor 32b. A common electrode voltage is applied to the other electrode of the liquid crystal capacitor 32b. In the following description, a data signal line, SG1 to SGn, connected to a green (G) pixel circuit 40g will be referred to as G data signal line, and a data signal line, SB1 to SBn, connected to a blue (B) pixel circuit 40b as B data signal line. It should be noted that a pixel circuit 40 may include an auxiliary capacitor.

The optical transmittance of the pixel circuit 40 (luminous intensity of the picture elements) depends on the voltage applied to the pixel circuit 40. To apply a voltage into the pixel circuit 40 connected to the scan signal line Gi and the data signal line SXj (X is one of R, G and B), a high level voltage (a voltage that turns the TFT 32a on) may be applied to the scan signal line Gi, and a voltage to be applied may be provided to the data signal line SXj. Applying a voltage designated by the display data Din into the pixel circuit 40 allows the luminous intensity of the picture element to be set to a desired level.

A photosensor 30 includes a capacitor 39a, a photodiode 39b and a sensor preamplifier 39c, and is provided for at least each blue picture element 40b (blue (B) pixel circuit 40b).

One electrode of the capacitor 39a is connected to the cathode terminal of the photodiode 39b (the connection will hereinafter be referred to as node A). The other electrode of the capacitor 39a is connected to a sensor readout line RWi, while the anode terminal of the photodiode 39b is connected to a sensor reset line RSi. The sensor preamplifier 39c is composed of a TFT that has a gate terminal connected to the node A, a drain terminal connected to a B data signal line SBj and a source terminal connected to a G data signal line SGj.

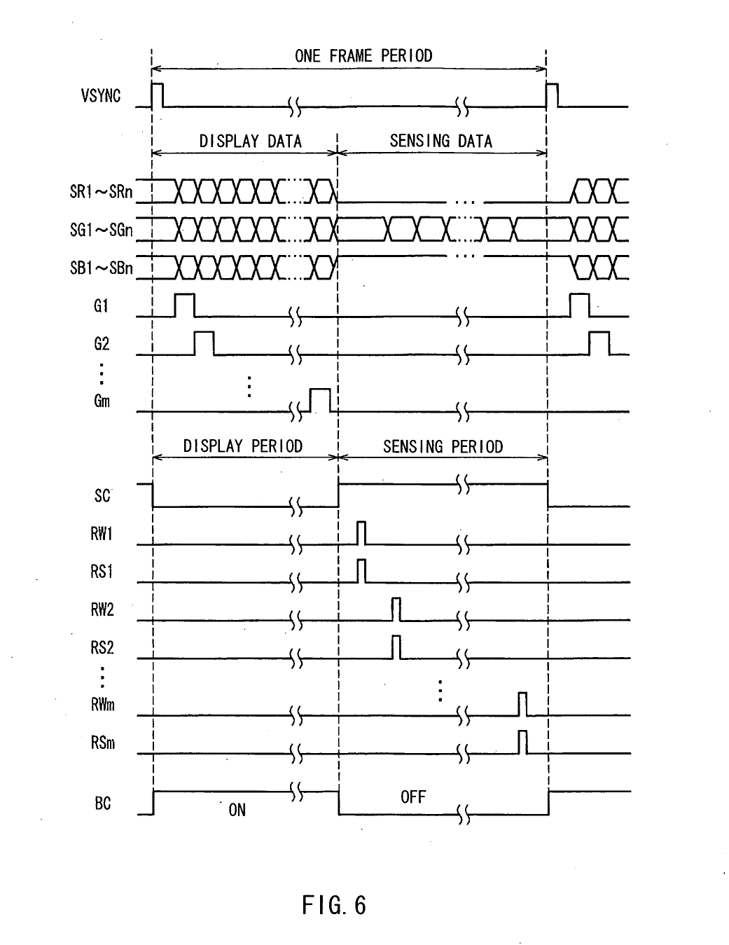

To measure the amount of light with a photosensor 30 connected to a sensor readout line RWi and a B data signal line SBj or the like, a predetermined voltage may be applied to the sensor readout line RWi and the sensor reset line RSi and a power supply voltage VDD may be applied to the B data signal line SBj in accordance with the timing chart shown in FIG. 6. After the predetermined voltage was applied to the sensor readout line RWi and the sensor reset line RSi, when light is incident on the photodiode 39b, an amount of current corresponding to the amount of incident light flows into the photodiode 39b and the voltage at the node A decreases by that amount of current. When the power supply voltage VDD is applied to the B data signal line SBj, the voltage at the node A is amplified by the sensor preamplifier 39c, and the amplified voltage is output to the G data signal line SGj. Thus, the amount of light measured at the photosensor 30 can be determined based on the voltage on the G data signal line SGj.

Surrounding the liquid crystal panel 32 are a scan signal line drive circuit 41, a data signal line drive circuit 42, a sensor row drive circuit 43, p sensor output amplifiers 44 (p is an inter of not less than one and not more than n) and a plurality of switches 45 to 48. The scan signal line drive circuit 41, the data signal line drive circuit 42 and the sensor row drive circuit 43 collectively correspond to the panel drive circuit 31 in FIG. 3.

The data signal line drive circuit 42 has 3n output terminals corresponding to the 3n data signal lines. One switch 45 is provided between one of the G data signal lines SG1 to SGn and the corresponding one of the n output terminals, and one switch 46 is provided between one of the B data signal lines SB1 to SBn and the corresponding one of the n output terminals. The G data signal lines SG1 to SGn are divided into groups each having p lines, and one switch 47 is provided between the kth G data signal line (k is an integer of not less than one and not more than p) in a group and the input terminal of the kth sensor output amplifier 44. Each of the B data signal lines SB1 to SBn is connected to one terminal of a switch 48, and the power supply voltage VDD is applied to the other terminal of the switch 48. In FIG. 4, n switches 45 to 47 are provided and one switch 48 is provided.

In the circuit shown in FIG. 4, different operations are performed during a display period and a sensing period. During a display period, the switches 45 and 46 are on, while switches 47 and 48 are off. During a sensing period, the switches 45 and 46 are off, the switch 48 is on, and the switch 47 is turned on in a time-division manner to sequentially connect each group of the G data signal lines SG1 to SGn with the input terminal of the corresponding one of the sensor output amplifiers 44.

During the display period shown in FIG. 6, the scan signal line drive circuit 41 and the data signal line drive circuit 42 are operated. In response to the timing control signal C1, the scan signal line drive circuit 41 selects one scan signal line out of the scan signal lines G1 to Gm for each line period, applies a high level voltage to the selected scan signal line, and applies a low level voltage to the other scan signal lines. The data signal line drive circuit 42 drives the data signal lines SR1 to SRn, SG1 to SGn and SB1 to SBn in a line-sequential manner based on the display data DR, DG and DB output from the image processing module 35. More particularly, the data signal line drive circuit 42 stores at least one row of the display data DR, DG and DB and applies a voltage designated by the one row of the display data to the data signal lines SR1 to SRn, SG1 to SGn and SB1 to SBn for one line period. It should be noted that the data signal line drive circuit 42 may drive the data signal lines SR1 to SRn, SG1 to SGn and SB1 to SBn in a dot-sequential manner.

During the sensing period shown in FIG. 6, the sensor row drive circuit 43 and the sensor output amplifier 44 are operated. In response to the timing control signal C2, the sensor row drive circuit 43 selects one signal line out of the sensor readout lines RW1 to RWm and the sensor reset lines RS1 to RSm for one line period, applies a predetermined readout voltage and reset voltage to the selected sensor readout/reset line, and applies a voltage different from the selection voltage to the other signal lines. Typically, one line period has different lengths for the display period and the sensing period. The sensor output amplifier 44 amplifies the voltage selected by the switch 47 and outputs it as a sensor output signal, SS1 to SSp.

In FIG. 6, the backlight control signal BC is at high level during a display period and is at low level during a sensing period. As such, the backlight 33 is on during a display period and is off during a sensing period. This reduces the effects of the backlight on the photodiode 39b.

### 1-5 Cross Sectional View of Liquid Crystal Panel

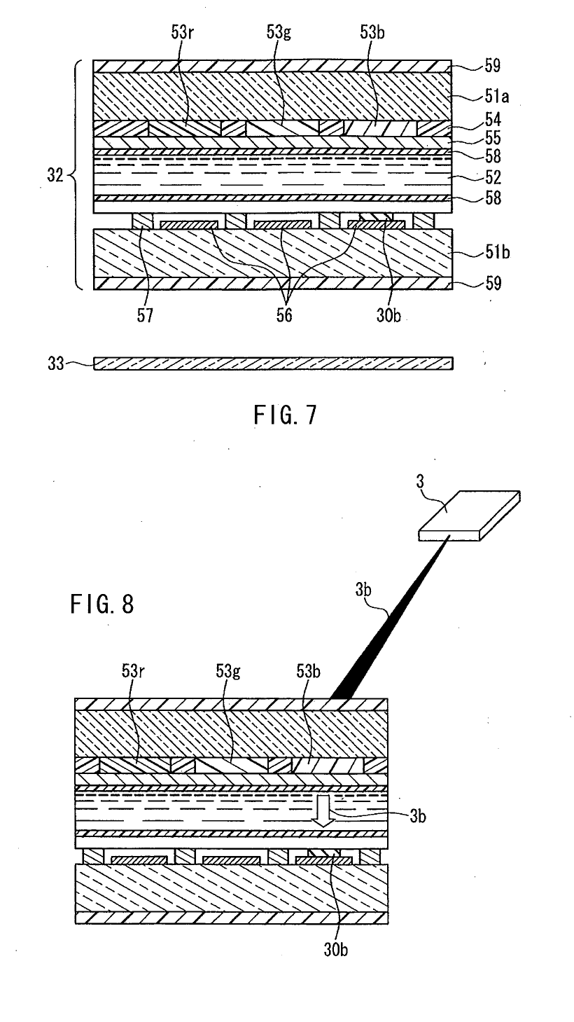

FIG. 7 is a cross sectional view of the liquid crystal panel 32. The liquid crystal panel 32 has a liquid crystal layer 52 interposed between two glass substrates 51a and 51b. Provided on one glass substrate 51a are color filters of three colors 53r, 53g and 53b, a light shielding film 54, an opposite electrode 55 and the like; provided on the other glass substrate 51b are pixel electrodes 56, data signal lines 57, a photosensor 30 and the like.

The photosensor 30 is provided near a pixel electrode 56 for which a blue color filter 53b is provided, for example. In this case, it is preferable that the photodiode 39b of the photosensor 30 is disposed to face the back side of the color filter 53 at its center to efficiently receive light that has passed the color filter 53.

An oriented film 58 is provided on each of the opposing sides of the glass substrates 51a and 51b, while a polarizing plate 59 is provided on each of the other sides thereof. Of the two sides of the liquid crystal panel 32, the side having the glass substrate 51a is the front side, while the side having the glass substrate 51b is the back side. The backlight 33 is provided to face the back side of the liquid crystal panel 32.

FIG. 8 is a schematic view of the panel where the photodiode 39b constituting a photosensor 30b of the liquid crystal panel 32 receives a laser beam of a blue wavelength from the pointing device 3 through the color filter 53b. The photodiode 39b constituting the photosensor 30b is formed to face the back side of the blue color filter 53b (to the bottom in FIG. 8), such that it can only receive a light beam 3b of blue wavelengths because light of other wavelengths than blue ones is blocked by the color filter 53b.

Thus, the light beam 3b of a blue wavelength reaches only a photodiode 39b constituting a photosensor 30b to be received, but is not received by a photodiode 39b constituting a photosensor 30r. In other words, the color filter 53 serves as a wavelength filter for the photosensor 30.

In the present embodiment, a light beam 3b of a blue wavelength is used to determine a location in an image illuminated by a laser beam.

### 1-6 Pixel Identification Process

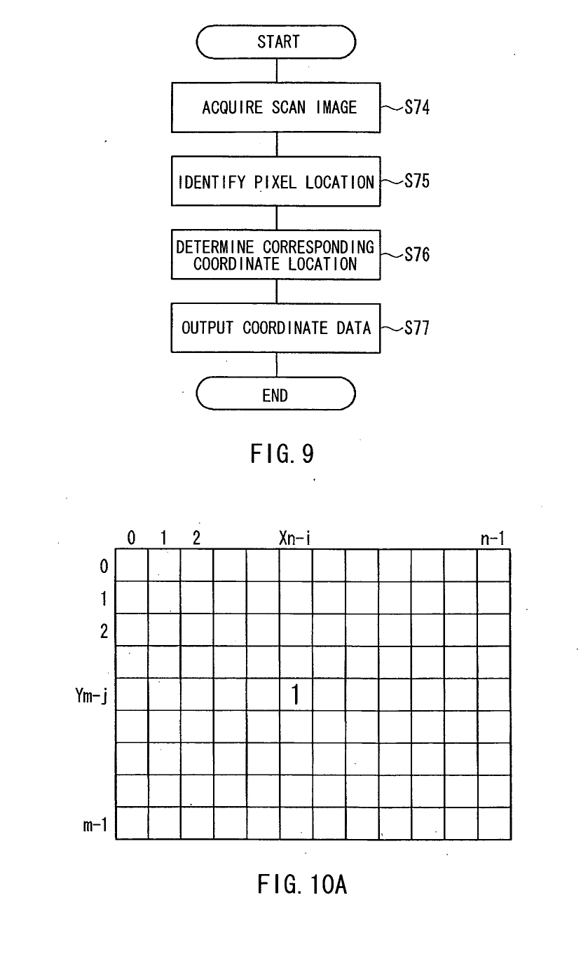

FIG. 9 is a flowchart illustrating a process by the display apparatus for identifying a location illuminated by a laser beam. The process illustrated in FIG. 9 is performed by the MPU 38 shown in FIG. 3 within one frame period.

The A/D converter 36 (FIG. 3) converts an analog output signal SS output from a photosensor 30 incorporated in the liquid crystal panel 32 into a digital signal. For example, if a blue laser beam from a laser beam is used to identify a location, an output signal SS from a photosensor 30 disposed to correspond to a blue picture element is converted to a digital signal.

The MPU 38 acquires this digital signal in the form of a scan image (step S74). Further, MPU 38 identifies a pixel location in the acquired scan image (step S75).

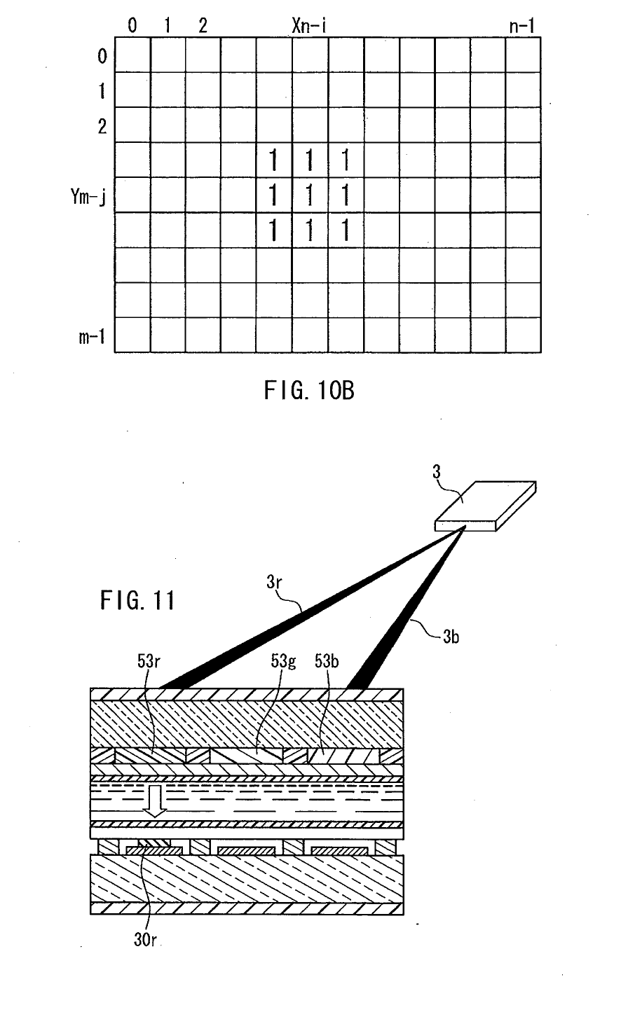

For example, FIG. 10A is a schematic view of a scan image with m×n pixels. As shown in FIG. 10A, if a scan image is binary-based with a predetermined threshold, a pixel with the value of “1” is considered to be a pixel illuminated by a laser beam, and the pixel location for this pixel is identified. In FIG. 10A, the pixel location (Xn-i, Ym-j) is identified.

FIG. 10B illustrates a scan image where a laser beam illuminates a large area and thus illuminates a plurality of pixels. In this case, the pixel location identified includes eight pixels surrounding the pixel location (Xn-i, Ym-j). It should be noted that the scan image of FIG. 10B can be obtained in the arrangements shown in FIGS. 5D and 5E.

Upon identifying the pixel location, the MPU 38 determines a coordinate location in the image corresponding to the identified pixel (step S 76). For example, as shown in FIG. 10A, coordinates corresponding to the identified pixel location, (Xn-i, Ym-j), are determined. If the screen resolution of the displayed image and the screen resolution of the liquid crystal panel are both “m×n”, it is determined that the coordinate location is the pixel location (Xn-i, Ym-j). It should be noted that if the image resolution is not equal to the screen resolution, the coordinates may be converted to determine a coordinate location corresponding to the pixel location.

It should be noted that if eight pixel locations including the pixel location (Xn-i, Ym-j) are identified, as shown in FIG. 10B, a coordinate location may be determined based on a predetermined rule. For example, a coordinate location may be determined based on the pixel closest to the weighted center of the group of the identified pixels. In this case, as shown in FIG. 10B, corresponding coordinates may be determined based on the pixel location (Xn-i, Ym-j) located at the weighted center of the group of the pixels with the value of “1”. Alternatively, in FIG. 10B, it may be determined that the coordinate location is the coordinates corresponding to all the pixel locations with the value of “1”.

Upon determining the coordinate location, MPU 38 outputs the coordinate data Cout for the determined coordinates to the external device (computer) 5 (step S 77). The external device 5 recognizes the pointed-to location based on the coordinate data output from the display apparatus 1 and outputs a cursor 8 (FIG. 1) superimposed on the output image.

For example, if the coordinate data Cout designates one single point, the cursor 8 is displayed such that the tip of the arrow-shaped cursor 8 (similar to a typical mouse cursor) is at the coordinate location.

Thus, the cursor 8 is accurately positioned at the location on the liquid crystal panel 32 of the display apparatus 1 illuminated by a laser beam (for example, a blue laser beam). Since the above process is performed in one frame period, the cursor 8 moves as the operator operating the laser pointer moves the illuminated location of the laser beam.

It should be noted that if the coordinate data Cout designates a plurality of points, the shape of the cursor may be formed to cover all the coordinates designated by the coordinate data Cout. In this case, the area illuminated by the laser beam is matched by the shape of the cursor and thus it is recognizable that the liquid crystal panel 32 is illuminated by the laser beam.

### 1-7 Command Detection Process

FIG. 11 is a schematic view of the panel where a photodiode 39b constituting a photosensor 30r of the liquid crystal panel 32 receives a laser beam of a red wavelength from the pointing device 3 through a color filter 53r. In the present embodiment, a light beam 3r of a red wavelength is used to detect a click command for an image illuminated by the laser beam.

The photodiode 39b constituting the photosensor 30r is formed to face the back side of the red color filter 53r such that it can only receive a light beam 3r of a red wavelength because, again, light of other wavelengths than red ones is blocked by the color filter 53r.

Thus, the light beam 3r of a red wavelength reaches only a photodiode 39b of a photosensor 30r provided to face the back side of a red picture element 40r to be received, but is not received by a photodiode 39b of a photosensor 30b provided to face the back side of a blue picture element 40b.

As shown in FIG. 9, in the display apparatus 1, the MPU 38 performs the process of identifying a location illuminated by a laser beam of a red wavelength (pixel identification process for red wavelengths) within one frame period, similar to identifying a location illuminated by a laser beam of a blue wavelength (pixel identification process for blue wavelengths). For example, a pixel identification process for red wavelengths is performed in one frame period other than a frame period for a pixel identification process for blue wavelengths. It should be noted that a pixel identification process for blue wavelengths and a pixel identification process for red wavelengths may be performed in one and the same frame period.

Then, if a command is to be detected using a red laser beam 3r, the A/D converter 36 converts an output signal SS from a photosensor disposed to correspond to a red picture element into a digital signal.

The MPU 38 acquires this digital signal in the form of a scan image (step S74). The MPU 38 then identifies a pixel location in the acquired scan image (step75). After a pixel location is identified, the MPU 38 determines a coordinate location in the image corresponding to the identified pixel (step S76).

Once the coordinate location is determined, the MPU 38 outputs, in addition to the coordinate data for the determined coordinates, command data that is to be generated when a laser beam of a red wavelength is detected (for example, a click command) to the external device (computer) 5 (step S77). The external device 5 recognizes the command location based on the coordinate data output from the display apparatus 1 and performs a predetermined command process (for example, a click command).

### 1-8 Conclusion

As described above, according to the present embodiment, a pointing device 3 may be used to directly illuminate a display surface of a display apparatus 1 with a laser beam of a blue wavelength to clearly display a pointer cursor on the display screen. Then, the display apparatus may be directly illuminated by a laser beam of a red wavelength to allow the apparatus to reliably perform a command process (for example, a click command) at a location where the pointer cursor is displayed.

Thus, a simple pointing device capable of emitting laser beams of only two colors may be used to allow a user to control the pointer and perform a click. Moreover, according to the present embodiment, using a simple pointing device will improve user experience in controlling the pointer. Furthermore, according to the present embodiment, disposing photosensors to correspond to the pixels will allow setting the precision in identifying a pointer location depending on the precision in disposing the photosensors.

### 2. Variation of First Embodiment

### 2-1 Apparatus Configuration

While the above embodiment described an implementation where a display apparatus 1 and an external device 5 constitute a pointing system, the present invention may be applied to an implementation that integrates a display apparatus 1 and an external device 5. Examples include a personal computer incorporating a monitor, a notebook computer, or a television where operations can be performed using a screen.

Further, while the above embodiment described a computer as the external device 5, the external device 5 may be a recorder/player using an optical disk, a hard disk or the like if the display apparatus is a television.

Furthermore, if the display apparatus is a television incorporating bidirectional communication functions, the present invention may be used for input operations. Thus, input operations may be performed to a television remotely and in a contactless manner using a laser pointer.

### 2-2 Commands

While the above embodiment described a command based on an illumination with a laser beam of a red wavelength in the context of a click command, other commands may be involved. For example, a right click command, a double click command or a drag command may be involved.

### 2-3 Laser Beam

While the above embodiment used a laser beam of a blue wavelength to obtain coordinate information and used a laser beam of a red wavelength to obtain command information, laser beams of other wavelengths in other colors that can be received by a photodiode 39b of a photosensor 30 through a color filter 53 may be used. For example, a laser beam of a red or green wavelength may be used to obtain coordinate information and a laser beam of a blue or green wavelength may be used to obtain command information.

It should be noted that the laser beam may be a continuous wave or a pulse wave.

### 2-4 Photosensors

While the above embodiment described a configuration where photosensors are disposed to correspond to blue and red picture elements, photosensors may be disposed to correspond to green picture elements as well. Specifically, as shown in FIG. 5E, a photosensor may be disposed at every picture element. In this case, photosensors corresponding to green picture elements may be used to measure the environmental illumination. For example, the threshold for the A/D converter 36 may be varied based on the measured environmental illumination to accurately determine whether light at a predetermined wavelength is incident on the liquid crystal panel 32.

### 3. Second Embodiment

The above embodiment described an implementation where a click command or the like for a location where the cursor 8 is displayed is detected when a photodiode 39b constituting a photosensor corresponding to a pixel displaying the cursor 8 receives a laser beam of a red wavelength. However, the detection of a click command does not have to involve the use of a photosensor corresponding to a pixel.

The present embodiment will describe an implementation where a command signal receiver provided in the display device 1 detects a click command or the like for a location where the cursor 8 is displayed based on a reception of a command signal based on an electromagnetic wave sent from a command signal sender of the pointing device 3.

### 3-1. Functional Block Diagram of Display Apparatus

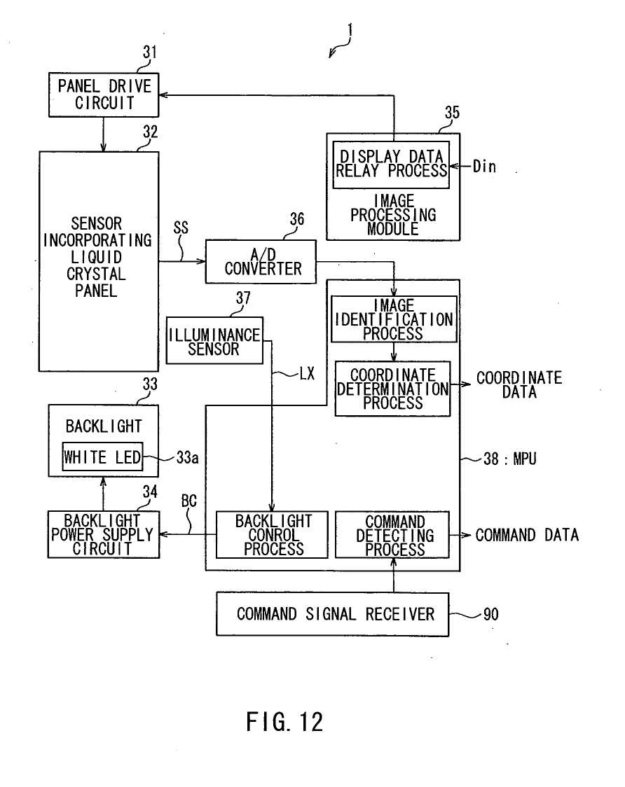

FIG. 12 is a functional block diagram showing a configuration of a display apparatus 1 according to the present embodiment. The display apparatus 1 shown in FIG. 12 includes, in addition to the display apparatus 1 shown in FIG. 3, a command signal receiver 90. A pointer device 3 according to the present embodiment includes a command signal sender (not shown).

When a laser pointer used as the pointer device 3 illuminates the display apparatus 1 with a laser beam 6, a cursor 8 is displayed on the display apparatus 1 (FIG. 1). When a click operation, such as a button depression, is performed on the pointer device 3 while the cursor 8 is displayed, the pointer device 3 emits a predetermined electromagnetic signal (for example, an infrared signal) towards the display apparatus 1.

When the command signal receiver 90 of the display apparatus 1 receives the predetermined electromagnetic signal emitted from the pointer device 3 via a signal receiving unit (not shown), it informs the MPU 38 that a command signal was received. Upon being informed, the MPU 38 outputs, to the external device 5, command data (for example, a click command) generated for the coordinate location of the cursor 8.

Thus, the present embodiment obtains coordinate information based on an output from a photosensor 30 that received a laser beam, and obtains command information based on an output from the command signal receiver 90 which received an electromagnetic signal.

It should be noted that electromagnetic signals emitted from the pointer device 3 towards display apparatus 1 may include, other than infrared signals, radio signals or ultrasonic signals. If a command is to be detected using an electromagnetic signal, the wavelengths of the laser beam emitted for pointing are not limited to blue wavelengths.

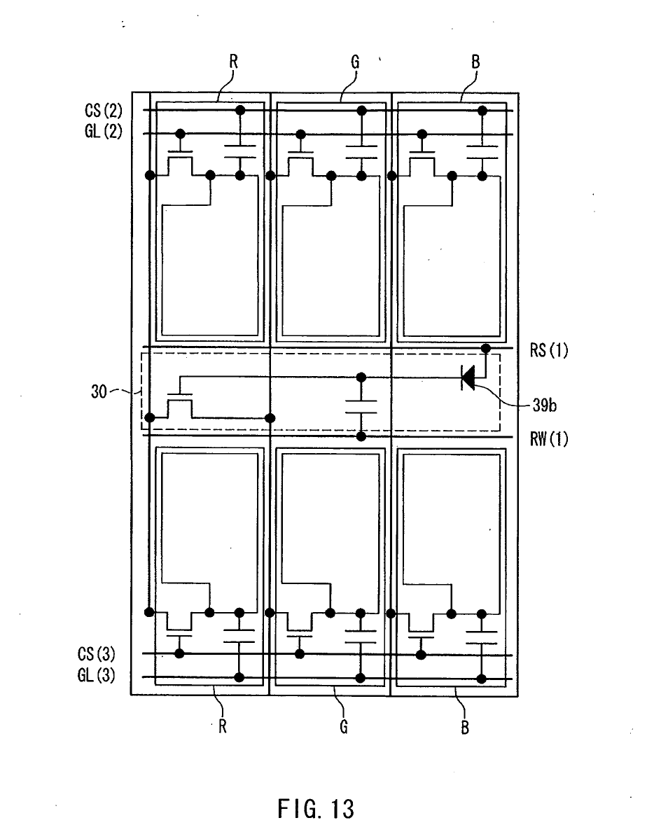

Further, the laser beam from the pointing device 3 does not have to be received through a color filter 53. For example, as shown in FIG. 13, a color filter R, a color filter G and a color filter B are provided on the front side of their respective picture elements forming one pixel, and no color filter is provided on the front side of the photodiode 39b constituting the photosensor 30 so as to allow the photodiode 39b to receive laser beams of all wavelengths.

This will improve the sensitivity of the photosensor 30 and allow it to detect a laser beam of small output. Laser beams of wavelengths of any one of white light, red light, blue light and green light may be employed.

### 4. Other Embodiments

Though some specific embodiments of the present invention have been described, the present invention is not limited to the above embodiments and various modifications can be made within the scope of the invention.

For example, an embodiment may combine the above first embodiment (including its variation) with the second embodiment. For example, a pointer location may be identified using a laser beam of a blue wavelength and a click command may be detected using a laser beam of a red wavelength and a double click command may be detected using a command signal based on an electromagnetic signal.

### INDUSTRIAL APPLICABILITY

The present invention is applicable for display apparatus, television reception apparatus and pointing systems including a light detector.

1. A display apparatus comprising:
a display module that displays a display image based on a plurality of pixels;
light detectors disposed to correspond to said pixels for detecting a pointer beam directed onto the display image on said display module and outputting a detection signal;
a pixel identifying module that identifies a pixel corresponding to a light detector that detected said pointer beam based on said detection signal; and
a coordinate determining module that determines coordinates of a location in said display image illuminated by said pointer beam based on the pixel identified by said pixel identifying module.

2. The display apparatus according to claim 1, further comprising:
a coordinate information output module that outputs coordinates determined by said coordinate determining module,
wherein said display module displays a display image superimposed with a pointing cursor in said coordinates.

3. The display apparatus according to claim 1, further comprising:
a command detection module that detects a predetermined command signal when light of a wavelength different from that of said pointer beam is detected.

4. The display apparatus according to claim 1, further comprising:
a command detection module that detects a predetermined command signal when a predetermined electromagnetic signal is received.

5. The display apparatus according to claim 1, wherein:
each of said light detectors is a photosensor provided for each of said pixels for detecting light from outside.

6. The display apparatus according to claim 1, wherein:
each of said light detectors is a photosensor provided for each of picture elements forming a pixel, for detecting light from outside.

7. The display apparatus according to claim 1, wherein:
each of said light detectors includes a photodiode.

8. The display apparatus according to claim 1, wherein:
said display module is a liquid crystal panel and said light detectors are integrated into an active matrix substrate of said liquid crystal panel.

9. A television reception apparatus using the display apparatus according to claim 1.

10. A pointing system comprising a display apparatus and a pointing device emitting a pointer beam, wherein:
said display apparatus is the display apparatus according to claim 1
